(19) United States
(12) Patent Application Publication
(10) Pub. No.: US 2012/0285366 A1
(43) Pub. Date: Nov. 15, 2012

(54) PRESCRIPTION BOTTLE INDICATION ADD-ONS TO REDUCE MEDICATION ERRORS

(76) Inventor: Ramiro M. Perez, (US)

(21) Appl. No.: 13/105,442

(22) Filed: May 11, 2011

(51) Int. Cl. G09F 3/00

(52) U.S. Cl. 116/278

(57) ABSTRACT

Label add-ons for decreasing medication errors and associated fatalities in the pharmacy dispensing process and for indicating the intended use of a drug in people ranging from the blind to the sighted, consisting of a circular, hollow, semi-flexible, ring-like material that is attached onto a prescription bottle. This invention serves as a vital safety-tool to the pharmacy dispensing process where duplicate medications become easily detected by the pharmacy personnel if device is properly attached to the prescription bottle. Imprinted, raised, or engraved legend in grapheme positioned over the outer surface of the device informs the reader the drug indication. Raised Braille coding and raised or engraved grapheme characters become vital in assisting the blind and visually impaired in identifying the drug through their sense of touch. Other distinctive features such as color, markings, and messages to uplift the mood on the apparatus, can further assist individuals in recognizing the correct drug indication. The apparatus can be reused from one prescription to the next if a patient desires a drug-refill.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2010-2011, Ramiro M. Perez. All Rights Reserved.

### BACKGROUND

1. Technical Field

The present invention relates to medication label add-ons, particularly to a flexible and colorful ring-like device housing health related legend on its outer surface. The device serves as an added safety tool to the pharmacy dispensing process by increasing detectability of duplicate medications for treating specific disease states. In addition, the present invention ensures consumers know the drug indication for their prescribed medications; and lastly, the device is key in the blind and visually impaired for assisting them in identifying their medications through their sense of touch. Additionally, other distinctive features on the apparatus, such as colour ties to drug indication, uplifting messages, or markings, will further enhance drug recognition.

2. Related Art

The U.S. Pharmacopeial Convention understands the importance of patient-centered prescription labeling. In fact, for 2012, evidence-based recommendations and updates to the USP Chapter 17, Prescription Container Labeling, call for larger font, information placement (most important information at the top), wider spacing, a simple language for patients to understand, and “purpose for use”. In 2006, the Institute of Medicine of the National Academies, set forth a series of recommendations aimed at decreasing medication errors. In 2010, the 10M recommended improvements in the labelling, naming, and packaging of drugs in order to reduce confusion and prevent medication errors. The challenge to reduce medication errors, and establish system-based patient safety environments continues as a top priority in the medical field.

Upon close examination of the pharmacy dispensing process, a series of key steps serve to ensure patient safety if properly enacted. Nonetheless, for 2010, the IOM estimated that 1.5 million patients would be hurt by medication errors. The present invention emerges as a valuable cost-effective safety tool to the pharmacy dispensing process where duplicate medications for a specific disease state become apparent by the pharmacist, the pharmacy staff, and the patient. Furthermore, the intended use for a particular drug must be known, or if in doubt questioned since pharmacists may have to manually attach the device to a patient's medication upon request or per company protocols.

Most medications dispensed in the United States, pursuant to a prescription written by a primary care physician or specialist, eventually makes its way to the pharmacy, where the pharmacist selects the correct medication, strength, and quantity; screens for drug-drug interactions; labels the medication with all required information; and dispenses it to the patient.

When patients receive their prescribed medication(s), most often, the actual intended used of the drug is not printed on the label. In cases where the actual intended use of the drug is printed on the label, it may not be composed of words that the patient may understand, or the information may be located in a not-so-visible position of the prescription label.

Very frequently, patients, or patient caretakers, will call the pharmacy and request that the intended use of the drug be placed on the prescription label. Other times, the patient may bring the prescription bottle, borrow a pen, and write the intended use directly on the prescription bottle themselves, to prevent medication errors. In other cases, patients may guess the drug indication and take the drug anyway, possibly causing harm to themselves.

Presently, there is no device in the pharmacy dispensing process that serves as a drug indication add-on, to further ensure patient safety and minimize duplicate prescriptions for specific disease states. Furthermore, an over-the-counter device that would give a patient the ability to attach a device to their prescription bottle that would indicate the intended use of a drug is not available on the market. Moreover, for blind people or visually impaired individuals, there is not a device available that allows them to identify their medication through their sense of touch.

### SUMMARY

The present invention is a valuable tool to the pharmacist, the pharmacy dispensing process, and the patient. This novel idea has enormous potential to reduce medication errors, improve patient safety, and should be accepted, engaged, and further challenged in the pharmacy industry. The current invention provides the pharmacist with an added safety tool for enhancing detectability of non-intended duplicate medications for treating a specific disease state once the device is properly attached to the prescription bottle. When two label add-ons with the same indication legend are attached to the prescription bottle, pharmacists and personnel easily recognize the number of drugs being used to treat a specific ailment; and the scenario becomes increasingly questioned, thus increasing patient safety awareness. In addition, this invention solves many of the struggles patients face in today's health care system and provides a solution for helping patients know the intended use of a particular drug. Moreover, this idea is useful for people with normal vision, as well as for those who are visually impaired or blind. Lastly, other features such as colour ties to drug indication, uplifting messages related to a particular drug therapy, and other markings or logos, further enhance drug recognition for a particular ailment. Distinctive features, including, dedicated colors, consistent messages to uplift the mood, or other markings, further enhance drug recognition and proper drug indication for specific disease states.

Labelling add-ons, as described for various embodiments herein, is a novel idea that allows consumers of prescription medications to know the intended use of the medication, and helps to prevent sound-alike or look-alike medications to be taken in error. Most importantly, it may also prevent irreversible harm or death attributed to medication errors prior to, or after, passing through the pharmacy dispensing process, by providing an added safety step in the process where duplicate medications become easily detectable by pharmacy personnel, and ultimately, by the patient.

The goal of the inventor is for pharmacy safety committees to integrate this novel invention and ideology right into the pharmacy dispensing process, where pharmacists can use the device to easily detect duplicate-medications being dispensed in error. Furthermore, patient safety is increased by preventing accidental drug intake due to lack of drug-indication knowledge by consumers of prescription drugs. Lastly, blind or visually impaired individuals would be able to identify a medication through their sense of touch.

The present invention provides several embodiments of a circular, hollow, semi-flexible, ring-like device that encircles and fits onto a prescription bottle, thereby serving as a label add-on for indicating the intended use of a drug for sighted people as well as for blind and visually impaired individuals. In an example embodiment, the apparatus comprises of a ring fabricated of a semi-flexible material and having an inner void and an outer surface. The inner void being of a dimension slightly larger than a dimension of a medication container upon expansion. The inner void is configured to capture the medication container therein. The outer surface bears a label corresponding to the content of the medication container. As used herein, the term “prescription bottle” is used as a synonym for prescription vial, prescription container, drug vial, or medication container. One embodiment shows a three-dimensional drawing of the invention, having the drug's intended use on the very front. Another embodiment shows a side view of the device where an extruded Braille legend is displayed in the center, and an embossed (extruded) grapheme legend extends outward from the device's outer surface. Another embodiment displays the device's inner surface attached to a drug vial allowing the reader to boldly recognize the medication's intended use. A separate embodiment allows the reader to appreciate how the device can be moved along the length of the prescription bottle and strategically placed in an area free of text, in order for the device not to cover important information on the prescription label, yet display the intended use of the medication. Legends with embossed, debossed (depressed pattern), and imprinted grapheme characters, along with Braille combinations, exhibit variations of the invention.

The apparatus is designed to slip into a desired location on the typical prescription bottle used in today's pharmaceutical market. A device with a larger diameter inner void, but for the same purpose, is constructed to slip onto larger prescription bottles. Other sizes can be fabricated to fit into additional bottle sizes, upon market demand. A raised, imprinted, or engraved, medical indication legend is situated on the outer surface of the device facing the reader, informing the reader of the disease state the medication was prescribed for. Aside from having the label add-on indicating the drug's intended use, different colors and distinctive marks on the device could be employed to further improve patient safety—assimilating drug indication and color. Lastly, embossed or debossed medical legend can be particularly useful for defining the use of a medication, particularly to the blind population or the visually impaired. Legend in Braille can be added at strategic sites along the device's outer surface next to the legend in grapheme, or positioned at opposite sites. This feature is incorporated in the present invention alone or in combination with embossed, debossed, or imprinted medical legend, to better address the needs of the blind and visually impaired.

Other advantages and features of this invention will become elucidated upon reading the detailed description section along with assigned figures and claims section.

### BRIEF DESCRIPTION OF THE DRAWINGS

Embodiments illustrated by way of example, and not limitation, in the figures of the accompanying drawings, in which:

FIG. 1a and 1b are schematic views of two air suspended label add-ons with embossed characters on the legend indicating two different disease states;

FIG. 2 illustrates a horizontal view of the label add-on with engraved legend characters for a common disease state;

FIG. 3 illustrates a side view of the device where raised Braille characters indicate a particular disease state, and raised grapheme characters toward the right side of the diagram erect from the device's outer surface;

FIG. 4 illustrates a schematic view showing the device with embossed characters at the center;

FIG. 5 shows the label add-on device with a legend stamped right at the center;

FIG. 6 is a rear view of the label add-on displaying raised Braille characters on the device's outer surface matching the same stamped disease state as shown on FIG. 5;

FIG. 7 illustrates a schematic view of a partial label add-on displaying the following disease state, “Diabetes” with its legend extruded from the device's outer surface;

FIG. 8a and FIG. 8b illustrate a single label add-on presenting engraved (debossed) legends around the device's outer surface at opposite positions. “for Weight Loss” (FIG. 8a), and an uplifting message, “Keep Exercising” (FIG. 8b);

FIGS. 9 and 10 illustrate a label add-on attached to the top end of a 16 and 30 dram prescription bottle; respectively;

FIG. 11 illustrates an alternative placement of the label add-on device onto the drug vial. (Site chosen at random in an area free of labelling information);

FIG. 12a illustrates the non-variant diameter length for 13-20 dram drug vials;

FIG. 12b illustrates the non-variant diameter length for 30-60 dram drug vials;

FIG. 13a illustrates a label add-on designed fit 13-20 dram drug vials;

FIG. 13b illustrates a label add-on designed fit 30-60 dram drug vials;

FIG. 13c illustrates a label add-on attached to the top end of a 16 dram drug vial; and

FIG. 13d illustrates a label add-on attached to the top end of a 30 dram drug vial.

### DETAILED DESCRIPTION

In the following description, for purposes of explanation, numerous specific details are set forth in order to provide a thorough understanding of an embodiment of the present invention. It will be evident, however, to one of ordinary skill in the art that embodiments may be practiced without these specific details.

Various embodiments of a prescription label add-on device that is attached to a drug vial as a safety tool in the pharmacy dispensing process, and also serving to point out the intended use of a prescribed drug are disclosed.

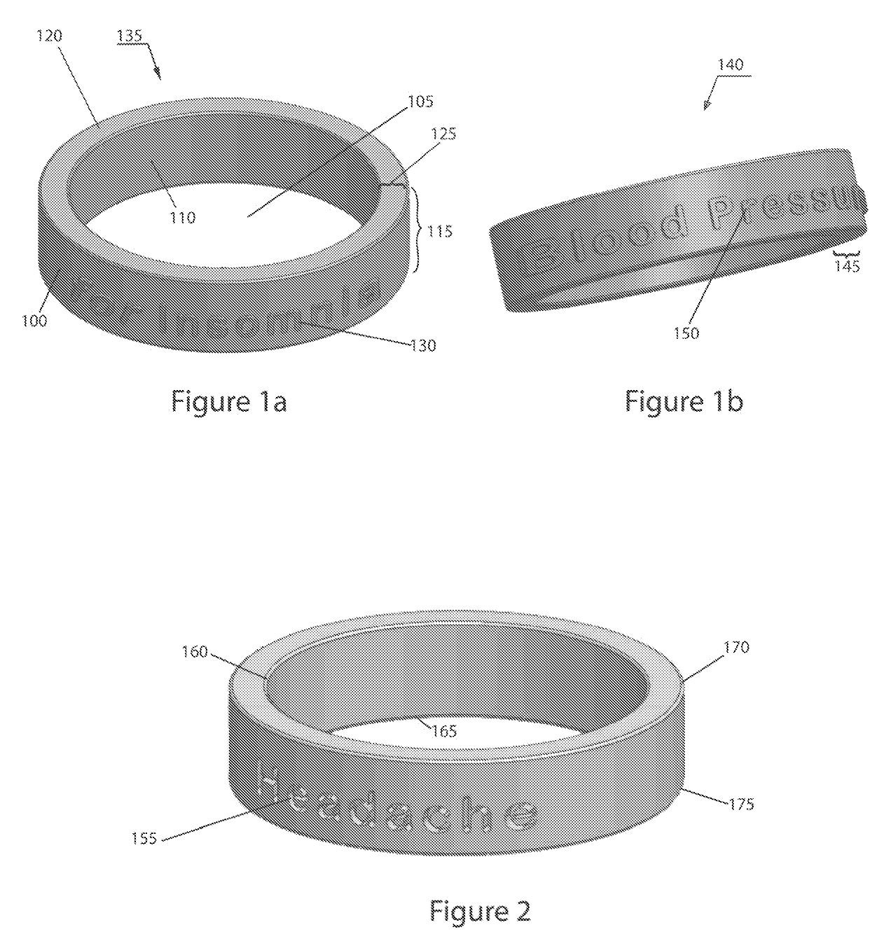

Referring to FIG. 1a, FIG. 1b and FIG. 2, the label add-on comprises of an outer surface 100 where the legend raised 130, depressed 155, or imprinted 210 is seated, and an inner surface 110, defining a void 105, that ultimately encircles a drug vial. The height of the device 115 spans in parallel from the upper inner-edge 160 to the lower inner-edge 165 and the upper outer-edge 170 to the lower outer-edge 175. For cosmetic interests, the actual edges of the device 160, 165, 170, 175 can be smoothed. Due to the nature of the device's geometry, its thickness 125, 145 is created by the distance between the inner surface 110 and the outer surface 100 equidistant from an imaginary point in the center of the circular hollow device, as seen on FIG. 1a and FIG. 1b.

FIGS. 1 through 8 show one example embodiment of a label add-on according to the present invention for indicating the use of a drug to people ranging from the blind to those with perfect vision. The round, hollow 105 semi-flexible ring-like device could be made colorful, consisting of silicon, neoprene, or other semi-flexible material capable of being molded to the desired shape, and expanded to fit tight against the slightly larger circular surface area 265, 285, 315, of a typical prescription drug vial.

FIG. 1a and FIG. 1b present a schematic view of two label add-ons with different legend in grapheme extruded from the device's outer surface 130, 150, 190, 195, 230. The user can view the indication legend, and touch the raised letters in cases where vision is limited or non-existent. A variation of the device could incorporate the legend engraved (debossed) 155 as displayed in FIG. 2, FIG. 8a, FIG. 8b.

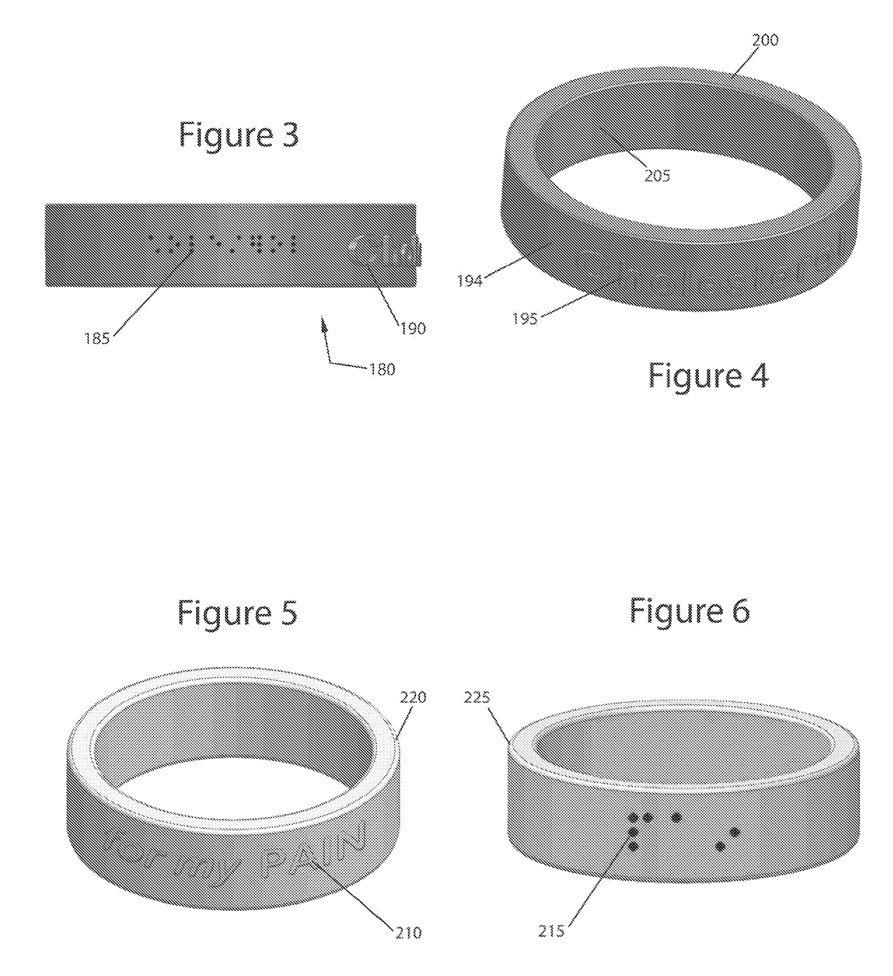

A schematic side view of the label add-on in FIG. 3 introduces the combination of raised Braille Code 185 and the typical, but extruded letters of the alphabet (grapheme) 190 on the right, each legend bearing the same indication for a particular drug. FIG. 4 presents a different schematic view of the label add-on as presented in FIG. 3 180. The upper surface 200 is well displayed in FIG. 4, extruded grapheme 195 extends from the outer surface 194 of the device, and the inner surface 205 is readily appreciated.

FIG. 5 depicts a stamped variation of the label add-on 210, “for my PAIN” with matching Braille 215 as shown in FIG. 6 for the same medical indication positioned roughly 180 degrees away from the stamped legend 210 in FIG. 5.

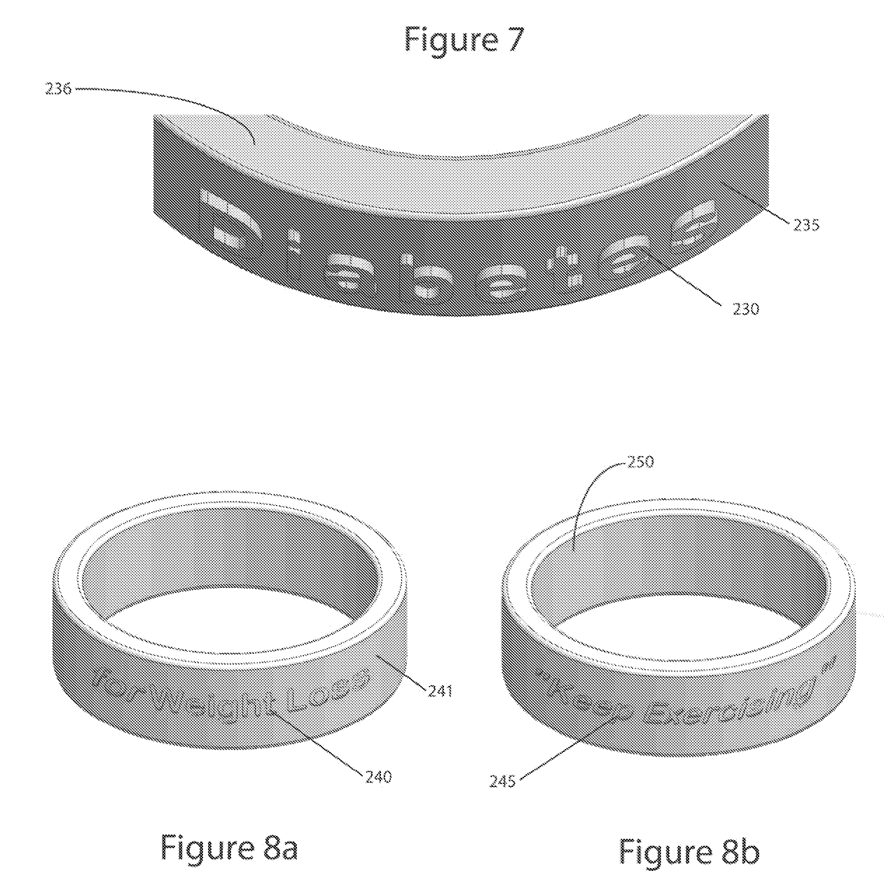

FIG. 7 depicts a sliced close-up front view of the label add-on indicating, “Diabetes” 230 as the extruded legend stemmed from the device's outer surface 235. The label add-on's upper surface 236 is clearly portrayed in this figure.

FIG. 8a and FIG. 8b illustrate a schematic view of a label add-on with a particular legend, chosen at random, displaying, “for Weight Loss” 240, stamped on device's outer surface 241; facing the reader. FIG. 8b, a rear view of the image shown in FIG. 8a, shows the uplifting message, “Keep Exercising” 245; which is related to the drug indication 240 selected on FIG. 8a. Note: The indication legend chosen was selected randomly and the uplifting message is one of many possible variations of messages that could correspond to the selected drug indication as shown on FIG. 8a and FIG. 8b.

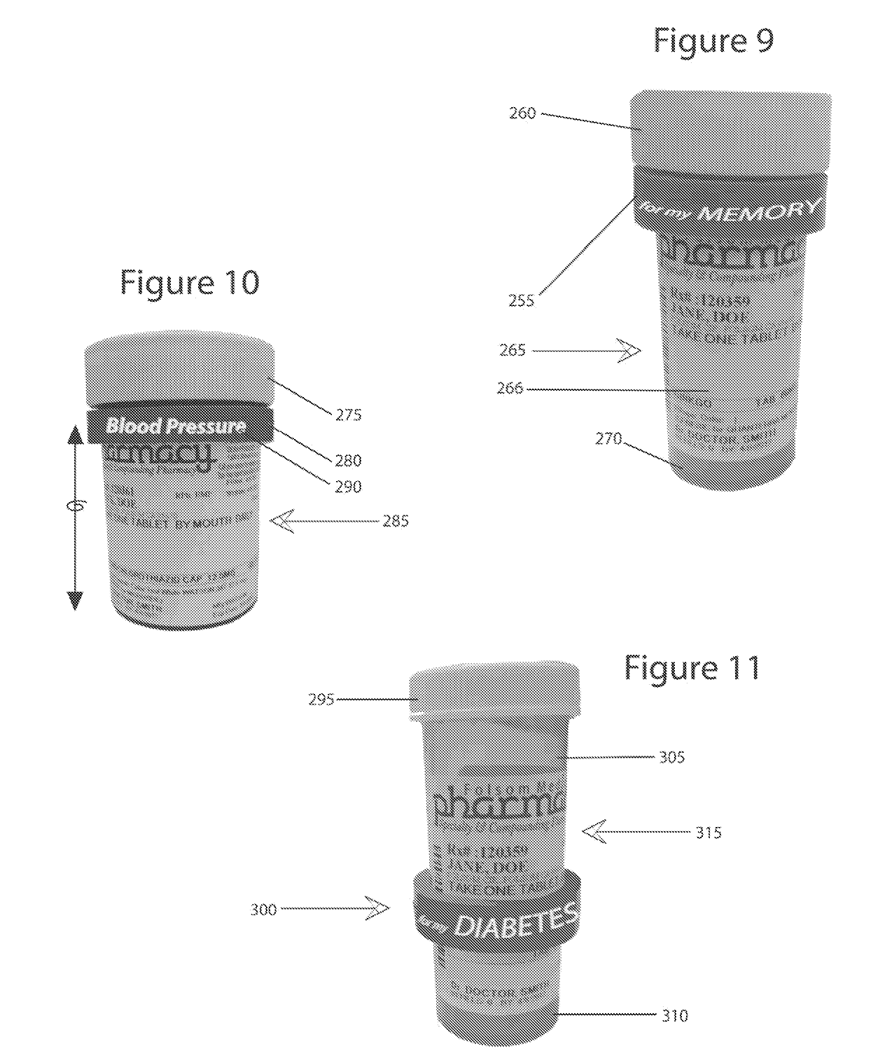

FIGS. 9 through 11 and 13 show example embodiments of label add-ons attached to drug vials of different sizes (16 dram, 30 dram) at different sites along the length of the drug vial 265, 280, 300.

FIG. 9 shows a label add-on 255 with the legend, “for my MEMORY” attached at the top end of the drug vial 265 near the vial's cap 260 over the top edge of a prescription label 266 that is adhered to the drug vial. Another site where this label add-on of this example embodiment could be situated near the lower end on the vial 270, where there is no legend, or at any other site on the prescription label where there is no legend.

FIG. 10 shows a labelled 28530-dram drug vial bearing the legend, “Blood Pressure” 290 on the label add-on 280 situated near the top end of a drug vial immediately below the cap 275. Note: The label add-on 280 position along the length of the drug vial can be easily moved from top to bottom or vice-versa to an area free of legend, or over less-important information on the drug label as seen on FIG. 11. 300.

FIG. 11 displays three key optimal sites 310, 305, 300 where the label add-on could be positioned along the length of a 16 dram drug vial to not cover any labelling information 315. The label add-on device 300 could also be positioned at other sites, if desired, to an area of less important labelling information.

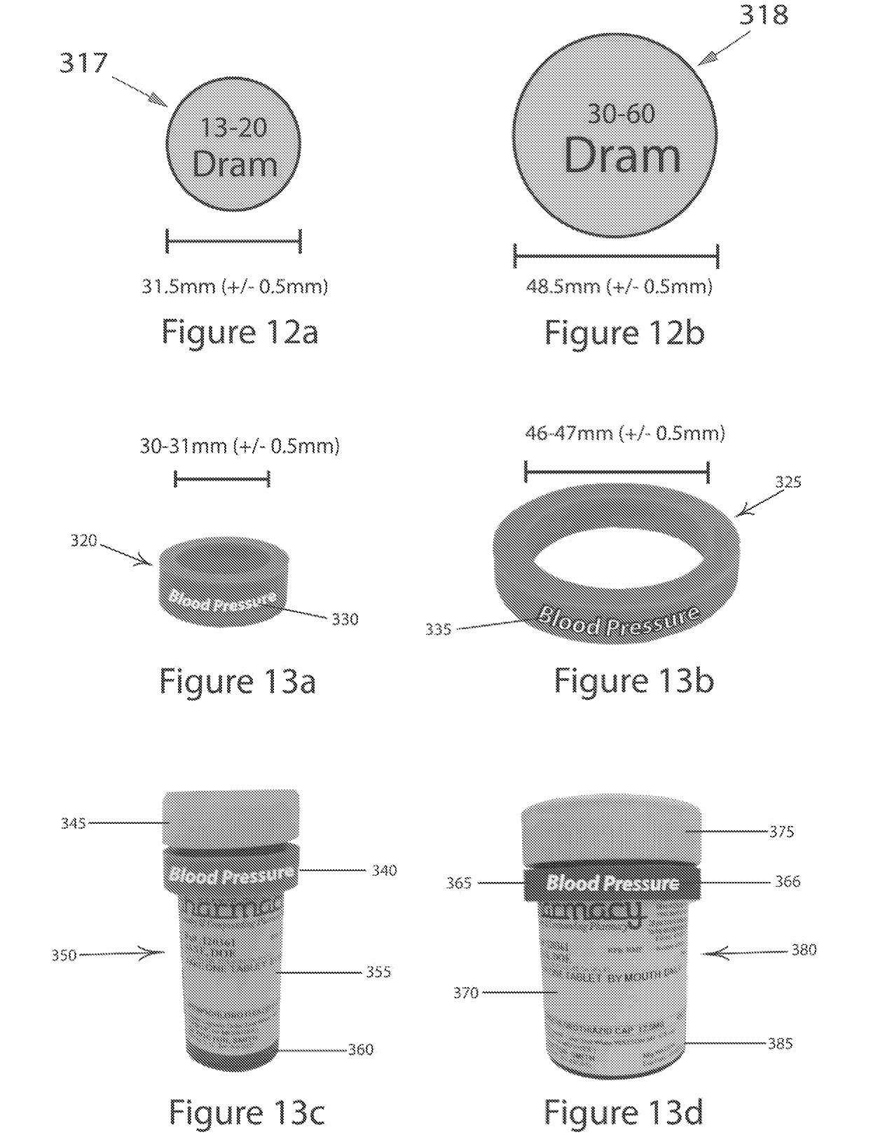

The most common diameter widths for prescription bottles in the U.S. are illustrated in FIGS. 12a and 12b. For vial size 13 to 20 dram 317, the diameter remains constant at roughly 31.5 mm. Likewise, for vial size 30 to 60 dram 318 the diameter averages 48.5 mm. In any case, FIGS. 13a and 13b illustrate how the label add-on is manufactured in different sizes, adjusted to properly fit on varied sizes of prescription bottles.

FIG. 13a illustrates how the label add-on device has a fixed inner void diameter 320 (30-31 min) designed to fit over 13 to 20 dram prescription bottles. Similarly, FIG. 13b illustrates a label add-on of a larger diameter 325 (46-47 mm) designed to fit 30 to 60 dram prescription bottles.

These two inner void diameter sizes are randomly selected in this example solely for illustration; however, other prescription bottle sizes may predominate in different regions of the USA; for which the inner void diameter of the device could be easily modified to accommodate market demand. The legend presented in FIG. 13a and FIG. 13b is raised 330, 335 from the device's outer surface.

FIG. 13c shows a label add-on 340 with embossed legend 330 situated at the top end of a 13 dram prescription bottle 350, just below the vial's lid 345. Similarly, FIG. 13d shows a label add-on 365 with embossed legend (“Blood Pressure”) 366 situated at the top end of a 30 dram prescription bottle 370 just below the bottle's cap 375. The label add-on shown in FIGS. 13c and 13d were inserted from the lower end of the prescription bottle 360, 385, and slipped all the way to the top end of the vial over the prescription label 355, 370 just below the container's cap 345, 375.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed. Description, with each claim standing on its own as a separate embodiment.

1.-16. (canceled)

17. A method comprising:
providing a ring fabricated of a semi-flexible material and having an inner void and an outer surface, the inner void being of a dimension slightly larger than a dimension of a medication container if the ring is expanded, the inner void being configured to capture the medication container therein;
applying a label to the outer surface of the ring, the label corresponding to a type of medication in the medication container and a prescribed use of the medication; and
causing the ring to be removably attached to the medication container, the ring and the label being configured to reduce pharmaceutical errors caused by misuse of the medication in the medication container.

18. The method as claimed in claim 17 wherein the semi-flexible material is a pliable plastic or rubber material.

19. The method as claimed in claim 17 wherein the label is embossed on the outer surface.

20. The method as claimed in claim 17 wherein the label is debossed on the outer surface.

21. The method as claimed in claim 17 wherein the label is pre-printed on the outer surface.

22. The method as claimed in claim 17 wherein the label includes extruded Braille characters.

23. The method as claimed in claim 17 wherein the ring and the label being configured to decrease medication errors and associated fatalities by serving, as an added safety tool at the level of the pharmacy dispensing process, ensuring that the drug's indication is readily visible and attached to the patient's prescription bottle.

24. The method as claimed in claim 17 wherein the ring and the label being configured to help detect duplicate medications where drugs having the same label add-on stand out; and therefore, pharmacy personnel easily detect and question the dispensing of duplicate medications.

25. The method as claimed in claim 17 wherein the ring and the label being configured to decrease health-related costs attributed to injuries caused by duplicate medications.

26. The method as claimed in claim 17 wherein the ring and the label being configured to help reduce death or near-death events due to medication errors attributed to the lack of intended use knowledge by consumers or patients.

27. The method as claimed in claim 17 wherein the ring and the label being configured to boldly indicate the prescribed use of the drug to the average consumer through an embossed, debossed, or imprinted label.

28. The method as claimed in claim 17 wherein the ring and the label being configured to indicate the prescribed use of the drug to the blind and visually impaired through the use of embossed, debossed, and Braille characters as part of the label.

29. The method as claimed in claim 17 wherein the ring and the label being configured to enhance recognition of a drug by employing distinctive features such as color or other markings in the device to further assist individuals in recognizing the correct drug for a particular ailment.

30. The method as claimed in claim 17 wherein the ring and the label being configured to help decrease the number of lawsuits to hospitals, drug chains, private pharmacies, and other medical entities by reducing medication errors attributed to wrongful drug use.

31. The apparatus as claimed in claim 1 wherein the ring and the label being configured to boldly state the use of a particular medication, wherein a health provider, patient, or trained patient delegate can attach the device on to the correct medication container, the health provider being from the group: pharmacist, physician, or veterinarian.

32. The method as claimed in claim 17 wherein the ring and the label being configured to uplift the mind and mood through the employment of aesthetically pleasing colors and encouraging phrases that convey positive meanings and outcomes.
